(19) United States
(12) Patent Application Publication
(10) Pub. No.: US 2021/0102633 A1
(43) Pub. Date: Apr. 8, 2021

(54) Fluid Control Device and Sensor Holding Member

(71) Applicant: Fujikin Incorporated, Osaka (JP)

(72) Inventors: Kazuhiro Fujine, Osaka (JP); Hidehiro Doya, Osaka (JP)

(73) Assignee: Fujikin Incorporated, Osaka (JP)

(21) Appl. No.: 16/497,781

(22) PCT Filed: Mar. 22, 2018
(86) PCT No.: PCT/JP2018/011394

§ 371 Date: Sep. 25, 2019

(30) Foreign Application Priority Data
Mar. 30, 2017 (JP) 2017-067858

(51) Int. Cl. F16K 27/00; G01K 1/14; F16K 37/00; G01K 13/02

(52) U.S. Cl. CPC F16K 27/00; G01K 13/026; F16K 37/0025; G01K 1/14

(57) ABSTRACT

A fluid control device is provided in which a temperature sensor is firmly fixed and the thermal contact of the temperature sensor with the inner circumferential surface of a leak port is reliably maintained. A fluid control device 3 holding a temperature sensor 7 has the temperature sensor 7 inserted into a leak port LP and a sensor holding member 8 provided directly above the leak port LP and holding the temperature sensor 7 in a state in which the temperature sensor 7 is inserted into the inside of the leak port LP. The sensor holding member 8 is formed of a base body part 81 disposed directly above the leak port LP and a through hole 8a provided on the base body part 81, the temperature sensor 7 being inserted into the through hole 8a, the through hole 8a communicating with the leak port LP. The base body part 81 has a length that fits in the width of the fluid control device 3 in the short-side direction. The through hole 8a of the sensor holding member 8 and the leak port LP form a predetermined angle.

### TECHNICAL FIELD

The present invention relates to a fluid control device holding a temperature sensor and a sensor holding member holding the temperature sensor.

### BACKGROUND ART

In the case in which the temperature of a fluid control device for use in a semiconductor fabrication apparatus is measured, the temperature is sometimes measured by inserting the temperature of a thermocouple (T/C), for example, into a leak port provided on the valve body of a fluid control device. This utilizes the leak port provided on an existing fluid control device for the insertion port of a temperature sensor, because the design of the fluid control device is not easily changed.

Since there is generally no standard for the diameter of the leak port, the diameter of the temperature sensor is not always fit to the diameter of the leak port. Thus, in the case in which the diameter of the temperature sensor is sufficiently smaller than the diameter of the leak port, the temperature sensor has to be externally fixed other than the leak port in order to prevent the temperature sensor from dropping off from the leak port.

On the other hand, even in the case in which the diameter of the leak port is appropriate to the diameter of the temperature sensor and the temperature sensor can be fit into the leak port, the temperature sensor might drop off due to expansion and contraction, because a thermal change is great at the place where the leak port is provided. The fluid control device can be installed in various orientations, such as horizontal, vertical, and up side down orientations, or the fluid control device itself vibrates, or the fluid control device is influenced by vibrations from surrounding facilities, and hence the reliability is demanded, which can maintain the thermal contact of the temperature sensor with the leak port in any orientation in order to fix the temperature sensor. In a demand nowadays that thin films are further downscaled, such as the use of a film deposition method referred to as ALD (Atomic Layer Deposition) in which thin films are formed in thicknesses at atom level or molecule level, the device difference between fluid control devices has to be reduced, and also in fixing the temperature sensor, it is naturally necessary to eliminate variations in fixing every device.

At this point, Patent Literature 1 proposes a fluid controller including a first fluid control device and a second fluid control device adjacent to each other and a thermal sensor configured to measure the temperature of a fluid flowing through the fluid passage of the first fluid control device, and the fluid control apparatus further includes an annular support member mounted on the outer circumferential surface of the actuator cap of any one of the first fluid control device and the second fluid control device and the support member is configured to support the thermal sensor.

### CITATION LIST

### Patent Literature

Patent Literature 1: WO 2014/136557 A

### SUMMARY OF INVENTION

### Technical Problem

Nowadays, a reduction in the size of the fluid control apparatus is further demanded, and the area of the actuator cap of the fluid control device is limiting the width of a gas line.

Under such situations, like the fluid control apparatus described in Patent Literature 1, it is not preferable to widen the breath by mounting the support member for the thermal sensor on the outer circumferential surface of the actuator cap. When the support member is mounted on the actuator cap, the support member is easily influenced by vibrations in the operation of the actuator.

Therefore, an object of the present invention is to provide a fluid control device in which a temperature sensor is firmly fixed and the thermal contact of the temperature sensor with the inner circumferential surface of a leak port is reliably maintained.

### Solution to Problem

In order to achieve the object, a fluid control device according to an aspect of the present invention is a fluid control device holding a temperature sensor, the fluid control device including: a temperature sensor inserted into a deep hole of the fluid control device; and a sensor holding member provided directly above the deep hole, the sensor holding member being configured to hold the temperature sensor in a state in which the temperature sensor is inserted into an inside of the deep hole, wherein the sensor holding member includes a base body part disposed directly above the deep hole, and a through hole provided on the base body part, the temperature sensor being inserted into the through hole, the through hole communicating with the deep hole, the base body part has a length that fits in a width of the fluid control device in a short-side direction.

The through hole of the sensor holding member and the deep hole may form a predetermined angle.

The sensor holding member may be made of a resin material having flexibility.

The through hole may have a recessed groove formed on an edge near an opening on a side to an opening of the deep hole.

In the through hole, a portion near an opening on a side opposite to the deep hole may be formed of a surrounding wall projecting from the base body part, the surrounding wall being thinner than the base body part.

The deep hole may be a leak port of the fluid control device.

A fluid control apparatus may be configured using the fluid control device.

A sensor holding member according to another aspect of the present invention is a member holding a temperature sensor on a fluid control device. The member is provided directly above a deep hole of the fluid control device. The member has a base body part disposed directly above the deep hole, and a through hole provided on the base body part, the temperature sensor being inserted into the through hole, the through hole communicating with the deep hole. The base body part has a length that fits in a width of the fluid control device in a short-side direction.

### Advantageous Effects of Invention

According to the fluid control device of the present invention, the temperature sensor is firmly fixed, and the thermal contact of the temperature sensor with the inner circumferential surface of the leak port is reliably maintained.

### BRIEF DESCRIPTION OF DRAWINGS

FIG. 1 is an external perspective view showing a fluid control apparatus configured of fluid control devices according to an embodiment of the present invention.

FIG. 2 is an external perspective view showing the fluid control device according to the embodiment.

FIG. 3 is a diagram showing the fluid control device according to the embodiment; FIG. 3(a) shows the front side, and FIG. 3(b) shows the side.

FIG. 4 is an external perspective view showing a main body configuring the fluid control device according to the embodiment.

FIG. 5 is an external perspective view showing a sensor holding member configuring the fluid control device according to the embodiment.

FIG. 6 is cross sectional views showing the sensor holding member according to the embodiment; FIG. 6(a) shows a cross section taken along line A-A, and FIG. 6 (b) shows across section taken along line B-B.

FIG. 7 is an external view showing the fluid control device according to the embodiment.

### DESCRIPTION OF EMBODIMENTS

In the following, a fluid control device 3 according to an embodiment of the present invention will be described with reference to the drawings.

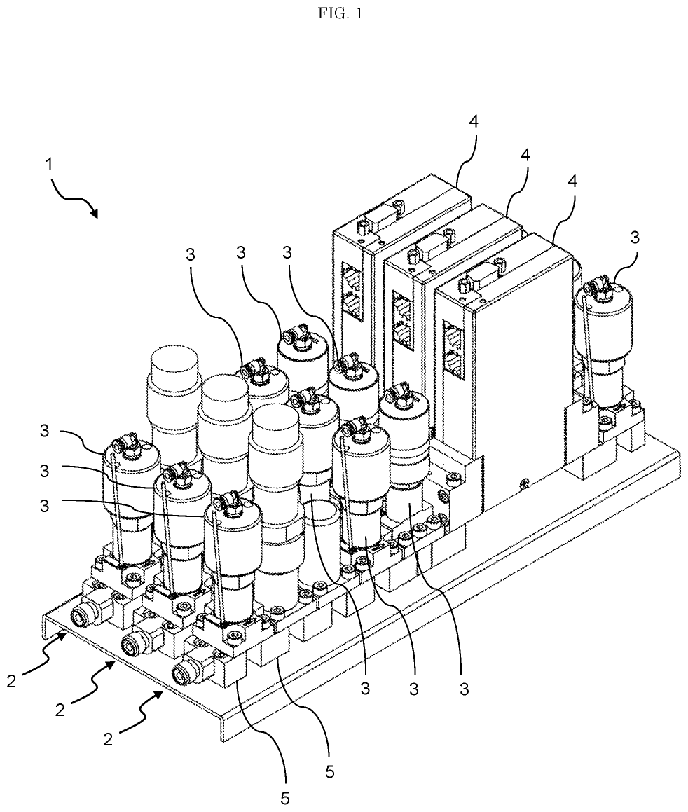

FIG. 1 shows a fluid control apparatus 1 including the fluid control devices 3 according to the embodiment. The fluid control apparatus 1 is configured of a plurality of gas lines 2 (in FIG. 1, three lines) adjacent to each other in the width direction, and the gas lines 2 are installed on a base sheet metal.

Note that in the following description, the directions of members, for example, are indicated as the top, bottom, left, and right depending on the directions in the drawings for convenience. However, since the fluid control apparatus 1 is installed in the top, bottom, left, and right orientations in the drawings corresponding to the specifications, the indicated directions do not limit the directions of members, for example, in embodying or using the present invention, unless otherwise specified.

On the gas lines 2 on a substrate, a plurality of fluid control devices 3 is disposed arranged in a line together with components, such as a mass flow control apparatus 4, and the fluid control devices 3 are connected through block-shaped joints 5.

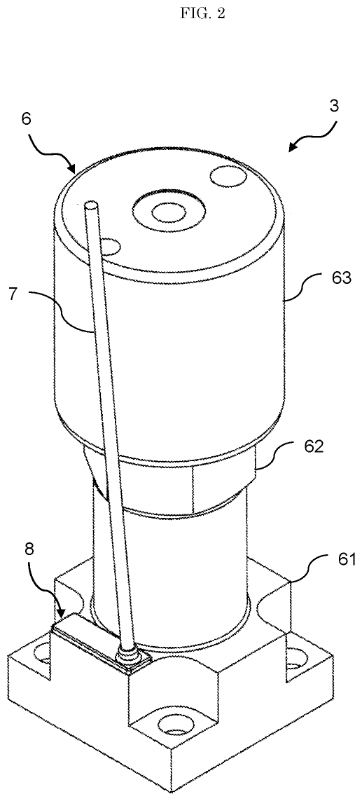

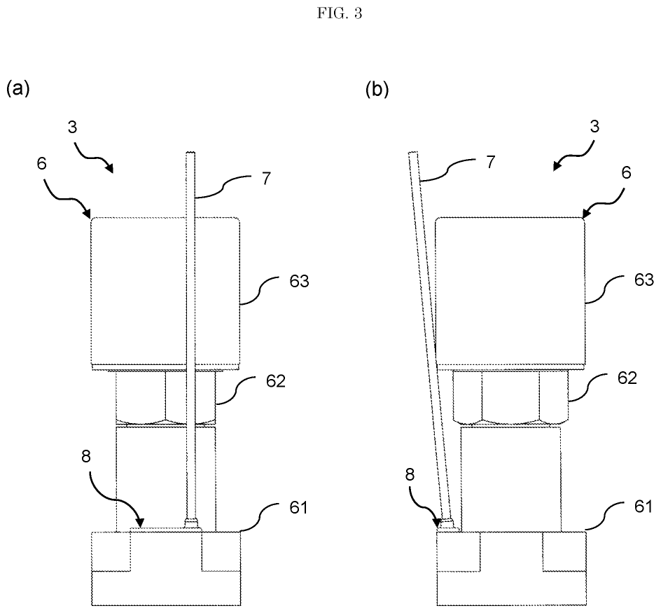

As shown in FIGS. 2 and 3, the fluid control device 3 is configured of a main body 6, a temperature sensor 7, and a sensor holding member 8.

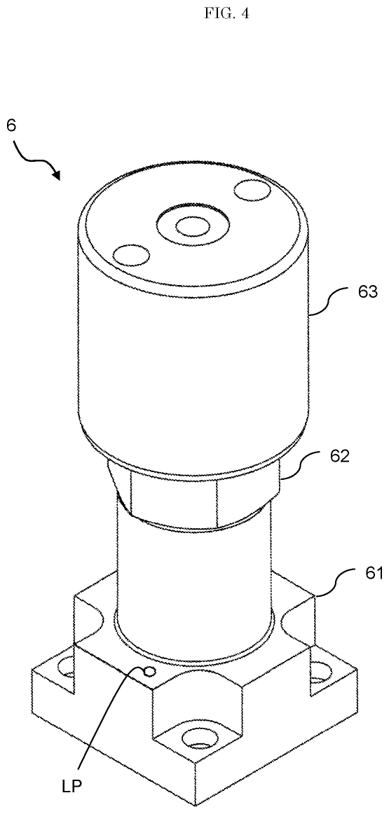

As shown in FIG. 4, the main body 6 is configured of a valve body 61, an actuator body 62 disposed on the valve body 61, and a casing 63 disposed on the actuator body 62.

The valve body 61 is provided with a passage (not shown in the drawing) through which a fluid circulates and a leak port LP that can detect the leakage of the fluid.

The leak port LP is configured of a through hole having a length in the vertical direction of the fluid control device 3. One end of the leak port LP communicates with the outside, and the other end is shielded with the block-shaped joint 5 and apart from the passage by a sealing member, such as a metal gasket, and functions as a deep hole having a predetermined depth after the assembly of the fluid fabrication apparatus 1.

Since the leak port LP is provided near the passage, the temperature in the inside of the leak port LP is measured, and hence the temperature can be regarded as the temperature of the fluid.

Note that in the embodiment, the leak port LP is used as the deep hole into which the temperature sensor 7 is inserted. However, as long as the temperature of the fluid or the temperature in the inside of the device can be measured by inserting the temperature sensor 7, a dedicated deep hole configured to measure the temperature may be provided, not limited to this. As long as the temperature sensor 7 can be inserted into the deep hole, the deep hole itself may be a through hole, not limited to a bottomed hole.

In the present example, a thermocouple is used for the temperature sensor 7. The thermocouple includes two types of metal lines. One end of each metal line is electrically connected to configure a temperature sensing part, and the other end of each metal line is installed on the place at the same reference temperature. From the difference of the thermoelectromotive force between two types of metals, the temperature difference between one end portion and the other end portion is measured as a voltage.

This temperature sensor 7 has one end inserted into the leak port LP and in contact with the inner circumferential surface of the leak port LP, and hence the temperature in the inside of the leak port LP is measured.

Note that in the drawings, only the temperature sensing part on one end side of the temperature sensor 7 configured as a thermocouple is schematically shown. The other end side of the temperature sensor 7 is connected to the control apparatus of the fluid control apparatus 1 with a wire, not shown.

In the present example, a thermocouple is used as the temperature sensor 7. However, any temperature measuring device can be used, which can be inserted into the inside of the leak port LP and measure temperatures, not limited to a thermocouple.

The sensor holding member 8 is provided directly above the leak port LP, and holds and fixes the temperature sensor 7 in the state in which the temperature sensor 7 is inserted into the inside of the leak port LP.

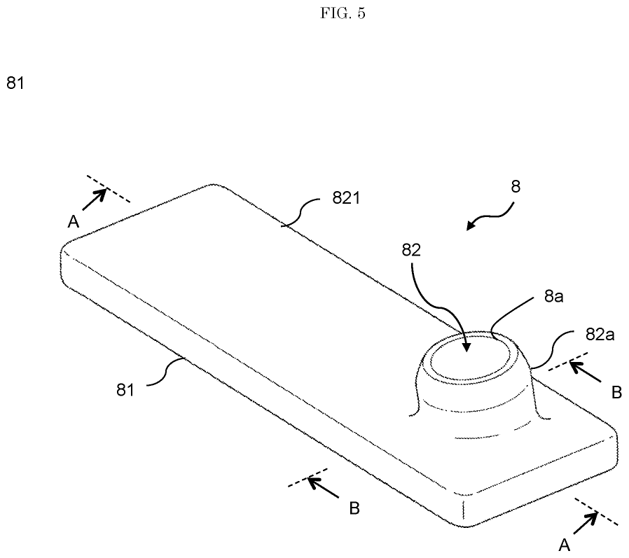

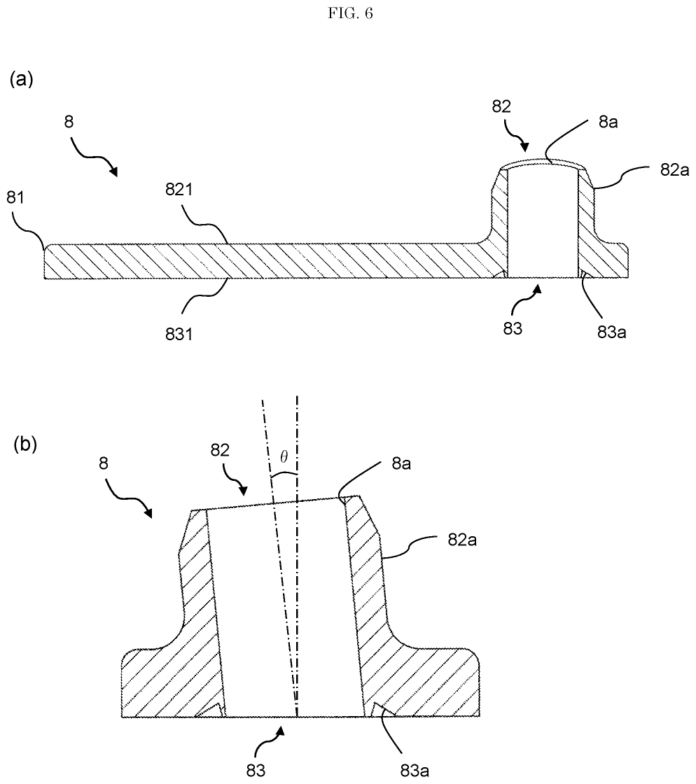

As shown in FIGS. 5 and 6, this sensor holding member 8 is configured of a base body part 81 in a flat plate shape disposed directly above the leak port LP, and a through hole 8a in a nearly tubular shape provided on the base body part 81, the through hole 8a having two ends opened.

The sensor holding member 8 is preferably made of a resin material, such as polytetrafluoroethylene (PTFE), including heat resistance or chemical resistance and having flexibility.

In the base body part 81, one face on the side opposite to the leak port LP configures a top face 821, and one face on the leak port LP side configures a mounting face 831 mounted on the valve body 61. In the present example, the sensor holding member 8 is adhered to a smooth surface on the valve body 61 with a heat resistant adhesive applied to the mounting face 831 or an adhesive tape, for example. However, the sensor holding member 8 may be fixed on the valve body 61 with a bolt, for example, or the sensor holding member 8 may attachably and detachably engage with a predetermined engaging unit, for example, not limited to adhesion. The sensor holding member 8 may be a part of the valve body 61, and may be integrated with the sensor holding member 8 and the valve body 61.

The length of the base body part 81 is formed in a size in the width of the valve body 61 or less. This is the length that fits in the width of the gas line 2. Thus, the width of the gas line 2 is defined only by the width of the fluid control device 3, and the width of the gas line 2 is not defined by the length of the sensor holding member 8. Note that the width of the valve body 61 in the present example shown in the drawings has the length direction and the width direction that are almost the same. However, in the case in which the width in the length direction is different from the width in the width direction, the size is the size that fits in the width in the short-side direction.

Note that the shape of the base body part 81 has a nearly rectangular shape in the planar view on the drawing. However, the base body part 81 only has to have a certain area necessary to mount the mounting face 831, or may be in the other shape, not limited to this.

The through hole 8a is a hole having a circular shape in a cross section, into which the temperature sensor 7 is inserted. This through hole 8a is provided at a location off-centered from the center of the base body part 81 and corresponding to the leak port LP, and the through hole 8a communicates with the leak port LP.

Note that the inner diameter of the through hole 8a is the diameter that is interference fit to the outer diameter of the temperature sensor 7. The temperature sensor 7 is inserted from the opening 82 on the top face 821 side into the opening 83 on the mounting face 831 side, and hence the temperature sensor 7 can be held. Thus, even in the case in which the fluid control apparatus 1 is used in the state in which the fluid control apparatus 1 is laterally inclined at an angle of 90 degrees, for example, the through hole 8a has the effect that prevents the temperature sensor 7 from dropping off.

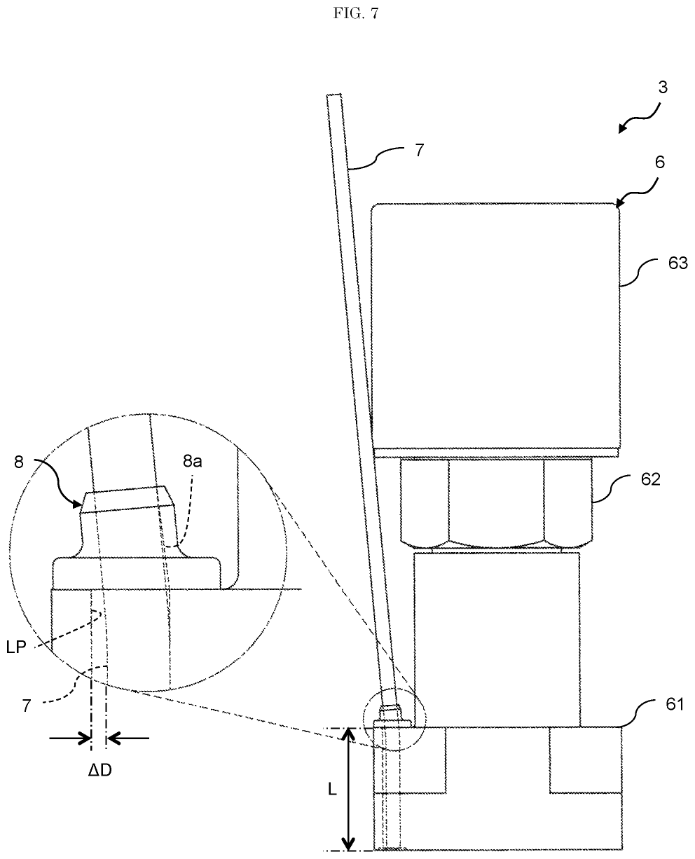

As shown in FIG. 6(b), the through hole 8a is formed in the direction at a slight angle from the orientation vertical to the mounting face 831 of the base body part 81. Specifically in the embodiment, the through hole 8a is angled in the length direction of the gas line 2 and in the direction apart from the main body 6. Thus, as shown in FIG. 7, the through hole 8a and the leak port LP form a predetermined angle θ in the length direction. As a result, the temperature sensor 7 inserted into the through hole 8a and inserted into the leak port LP contacts the inner circumferential surfaces of the through hole 8a and the leak port LP, and the temperature sensor 7 is gently bent at a portion at which the through hole 8a communicates with the leak port LP. As a result that the temperature sensor 7 is thus bent, the temperature sensor 7 contacts the inner circumferential surface of the leak port LP with restoring force. Thus, the state in which the temperature sensor 7 is in thermal contact with the inner circumferential surface of the leak port LP is easily maintained.

In the embodiment, the predetermined angle θ is about five degrees. In the following, the criteria will be described. From the conditions in which the temperature sensor 7 contacts the inner circumferential surface of the leak port LP, when the difference between the outer diameter of the temperature sensor 7 and the inner diameter of the leak port LP is ΔD and the depth of the temperature sensor 7 to be inserted into the leak port LP is L, the formula below has to be satisfied

angle θ>θₘᵢₙ=arctan (−ΔD/L)≈ΔD/L. In the embodiment, θₘᵢₙ=1.64[°], where ΔD=0.4 L=14. The restoring force becomes greater as the angle θ is made greater than the angle θₘᵢₙ that is necessary at the minimum, and the holding power on the temperature sensor 7 becomes greater. In order to prevent the interference with the device installed adjacent to the fluid control device 3, the temperature sensor 7 has to be located close to the orientation vertical to the mounting face 831, the value is desirably approximately θ<10 [°], and the angle θ in this range can satisfy an allowable bend R of the thermocouple used as the temperature sensor 7.

In the through hole 8a, the portion near the opening 82 is formed of a surrounding wall 82a projecting from the top face 821 of the base body part 81. This surrounding wall 82a is formed thinner than the portion where the through hole 8a is formed by the base body part 81, and the portion near the end portion of the surrounding wall 82a is gradually thin toward the side opposite to the base body part 81.

On the through hole 8a, an annular recessed groove 83a is formed on the edge of the opening 83. The recessed groove 83a is gradually narrow in width toward the groove bottom (gradually wide in width toward the mounting face 831 side).

At this point, in the present example, the through hole 8a and the leak port LP form the predetermined angle θ in the depth direction, as described above. The temperature sensor 7 inserted into the through hole 8a and obliquely inserted into the leak port LP contacts the inner circumferential surface of the through hole 8a or the leak port LP with restoring force in the state in which the temperature sensor 7 is gently bent. As a result, although the temperature sensor 7 does not easily drop off from the leak port LP, the stress concentrates from the temperature sensor 7 on the inner circumferential surface of the through hole 8a, specifically the inner circumferential surfaces near the openings 82 and 83 at two ends of the through hole 8a, leading to a possible cause that the temperature sensor 7 is broken or the sensor holding member 8 is removed from the valve body 61.

By contrast, near the opening 82 on the top face 821 side, the through hole 8a is formed of the surrounding wall 82a that is thin and projects from the top face 821 of the base body part 81, and hence the stress applied from the temperature sensor 7 to the inner circumferential surface of the through hole 8a near the opening 82 is absorbed by the surrounding wall 82a. Near the opening 83 on the mounting face 831 side, the annular recessed groove 83a is formed at the edge of the through hole 8a, and hence the stress applied from the temperature sensor 7 to the inner circumferential surface of the through hole 8a near the opening 83 is absorbed by the recessed groove 83a.

In any of the openings 82 and 83, the stress easily concentrates as closer to the opening the end portion. However, in the opening 82, the thickness of the surrounding wall 82a is gradually thin toward the side opposite to the top face 821, and in the opening 83, the width of the recessed groove 83a is gradually wide toward the side opposite to the mounting face 831. Thus, the stress concentrating on the tip end portion can be more effectively released.

Accordingly, the stress is prevented from concentrating while the state in which the temperature sensor 7 does not easily drop off from the leak port LP is maintained, and the temperature sensor 7 can be prevented from being broken, or the sensor holding member 8 can be prevented from being removed from the valve body 61.

Since the surrounding wall 82a is formed thin, the heat of the valve body is not easily transferred to the opening 82, and the valve body is easily cooled by the outside air. Thus, a reduction in holding power due to loose fitting caused by thermal expansion can be prevented.

Note that in the embodiment, the base body part 81 is formed in a flat plate shape. However, the base body part 81 may be formed in a block shape having a certain thickness, not limited to this. Also in the case in which the base body part 81 is formed in a block shape, the surrounding wall 82a can be provided on the top face 821 side. However, the base body part 81 has a thickness, and hence the recessed groove 83a can also be formed on the top face 821 side similarly on the mounting face 831 side.

According to the fluid control device 3 of the embodiment as described above, the temperature sensor 7 is fixed in the state in which the temperature sensor 7 is obliquely inserted to the leak port LP. As a result, regardless of vibrations or temperature changes in association with the operation of the fluid control device 3 or the chamber and further regardless of the installing direction of the fluid control device 3, the temperature sensor 7 is firmly fixed without the temperature sensor 7 dropping off from the leak port LP, and the state in which the temperature sensor 7 is in thermal contact with the inner circumferential surface of the leak port LP is reliably maintained.

By the surrounding wall 82a and the recessed groove 83a near the openings 82 and 83 of the through hole 8a, the concentration of the stress applied from the temperature sensor 7 to the through hole 8a of the sensor holding member 8 and to the inner circumferential surface of the leak port LP is avoided, and the breakage of the temperature sensor 7 and the removal of the sensor holding member 8 from the valve body 61 can be prevented.

The sensor holding member 8 is provided on the valve body 61, and hence the sensor holding member 8 is not easily influenced by vibrations in association with the operation of the actuator.

Also with a valve in a shape different from the shape in the present example, the temperature sensor 7 can be held on the leak port LP by the sensor holding member 8 according to the embodiment, which provides versatility, as long as the mounting face 831 of the sensor holding member 8 can be reserved around the leak port LP.

The length of the sensor holding member 8 is in the size of the width of the valve body 61 or less, and hence the width of the gas line 2 is not defined by the length of the sensor holding member 8, contributing to a reduction in the size of the fluid control device 3. Thus, even the fluid control device 3 according to the embodiment including the temperature sensor 7 and the sensor holding member 8 can also be installed on the vicinity of the chamber having a small space around which various members are disposed.

### REFERENCE SIGNS LIST

1 Fluid control apparatus
2 Gas line
3 Fluid control device
4 Mass flow control apparatus
5 Block-shaped joint
6 Main body
61 Valve body
62 Actuator body
63 Casing
7 Temperature sensor
8 Sensor holding member
8a Through hole
81 Base body part
82 Opening
821 Top face
82a Surrounding wall
83 Opening
831 Mounting face
83a Recessed groove
LP Leak port (deep hole)

1. A fluid control device holding a temperature sensor, the fluid control device comprising:
a temperature sensor inserted into a deep hole of the fluid control device; and
a sensor holding member provided directly above the deep hole, the sensor holding member being configured to hold the temperature sensor in a state in which the temperature sensor is inserted into an inside of the deep hole, wherein
the sensor holding member includes
a base body part disposed directly above the deep hole, and
a through hole provided on the base body part, the temperature sensor being inserted into the through hole, the through hole communicating with the deep hole,
the base body part has a length that fits in a width of the fluid control device in a short-side direction, and
the through hole of the sensor holding member and the deep hole form a predetermined angle.

2. The fluid control device according to claim 1, wherein the sensor holding member is made of a resin material having flexibility.

3. The fluid control device according to claim 2, wherein the through hole has a recessed groove formed on an edge near an opening on a side to an opening of the deep hole.

4. The fluid control device according to claim 2 or 3, wherein in the through hole, a portion near an opening on a side opposite to the deep hole is formed of a surrounding wall projecting from the base body part, the surrounding wall being thinner than the base body part.

5. The fluid control device according to claim 1, wherein the deep hole is a leak port of the fluid control device.

6. A fluid control apparatus using the fluid control device according to claim 1.

7. A sensor holding member holding a temperature sensor on a fluid control device, wherein
the sensor holding member is provided directly above a deep hole of the fluid control device,
the sensor holding member includes
a base body part disposed directly above the deep hole, and
a through hole provided on the base body part, the temperature sensor being inserted into the through hole, the through hole communicating with the deep hole, and
the base body part has a length that fits in a width of the fluid control device in a short-side direction.
